(19) United States
(12) Patent Application Publication
(10) Pub. No.: US 2008/0079650 A1
(43) Pub. Date: Apr. 3, 2008

(54) RF INTERFACE FOR ACCOMODATING DIFFERENCE ANTENNA IMPEDANCES

(75) Inventors: NICOLAS CONSTANTINIDIS, Cresserons (FR); GUILLAUME CRINON, Douvres-la-De'livrande (FR); ALAN WESTWICK, Austin, TX (US)

Correspondence Address: HOWISON & ARNOTT, L.L.P, P.O. BOX 741715, DALLAS, TX, 75374-1715, US

(73) Assignee: SILICON LABORATORIES INC., AUSTIN, TX (US)

(21) Appl. No.: 11/538,043

(22) Filed: Oct. 2, 2006

(51) Int. Cl. H01Q 1/50

(52) U.S. Cl. 343/858

(57) ABSTRACT

An RF interface for interfacing between a differential transceiver and at least two antenna ports, which transceiver has at least two receive inputs for receiving RF signals from the at least two antenna ports and at least two transmit outputs for transmitting RF signals to the at least two antenna ports. A multiplexing device is provided for interfacing between the transceiver and the at least two antenna ports and selectively interface transmitted RF signals to one or both of the at least two antenna ports or selectively interface received signals from one or both of the at least two antenna ports to respective receive inputs of the transceiver. A controller is provided for controlling the multiplexer to operate in either a receive mode or a transmit mode and, in the receive mode, operate in either a single ended mode to interface one of the at least two antenna inputs to one of the inputs of the transceiver or a differential mode to interface both of the at least two antenna inputs to respective inputs of the transceiver. A matching network controlled by the controller matches the impedance of the at least two antenna ports to the input of the transceiver when in the receive mode, and operable to select between at least two different antenna impedances.

### TECHNICAL FIELD OF THE INVENTION

The present invention pertains in general to antenna interface circuits to an RF transceiver and, more particularly, to internal matching networks on a monolithic RF transceiver fabricated on a single chip.

### BACKGROUND OF THE INVENTION

With the improvement of processing techniques for integrated circuits, the ability to fabricate circuitry that operates at very high frequencies, such as 2.4 GHz, and the ability to fabricate RF transmitters and receivers has improved significantly. Typically, these transceivers are comprised of some type of low noise amplifier (LNA) that is interfaced with an input terminal, and an output power amplifier for driving the terminal. To this terminal is connected some type of antenna, this being passed through some type of antenna interface, balanced or unbalanced. The purpose for this interface is to provide some type of matching network to match the impedances between the antenna and the amplifier, either for the transmission operation or the reception operation. The RF input, depending upon the design, will have some unique impedance associated therewith, which unique impedance will be comprised of a real and an imaginary part. In order to accommodate a maximum transmitted power, it is important that the output impedance of the amplifier, looking into the amplifier, be matched to the impedance of the antenna, looking into the antenna. However, for some frequency bands, such as the ISM band (Industrial, Scientific and Medical), various applications will require different interfaces to the antenna. For example, some will be very low cost interfaces which are limited to an antenna that can be realized on a bare printed circuit. Some will be more elaborate, requiring an antenna in combination with a filter, or a surface acoustic wave (SAW) filter and/or a power amplifier (PA). Some interfaces may even require two antennas with possibly some filtering associated therewith. Each of these configurations, as one would expect, will require different matching networks to accommodate the different impedance levels between the RF input/RF output and the antenna.

### SUMMARY OF THE INVENTION

The present invention disclosed and claimed herein, in one aspect thereof, comprises an RF interface for interfacing between a differential transceiver and at least two antenna ports, which transceiver has at least two receive inputs for receiving RF signals from the at least two antenna ports and at least two transmit outputs for transmitting RF signals to the at least two antenna ports. A multiplexing device is provided for interfacing between the transceiver and the at least two antenna ports and selectively interface transmitted RF signals to one or both of the at least two antenna ports or selectively interface received signals from one or both of the at least two antenna ports to respective receive inputs of the transceiver. A controller is provided for controlling the multiplexer to operate in either a receive mode or a transmit mode and, in the receive mode, operate in either a single ended mode to interface one of the at least two antenna inputs to one of the inputs of the transceiver or a differential mode to interface both of the at least two antenna inputs to respective inputs of the transceiver. A matching network controlled by the controller matches the impedance of the at least two antenna ports to the input of the transceiver when in the receive mode, and operable to select between at least two different antenna impedances.

### BRIEF DESCRIPTION OF THE DRAWINGS

For a more complete understanding of the present invention and the advantages thereof, reference is now made to the following description taken in conjunction with the accompanying Drawings in which:

FIG. 1a illustrates a diagrammatic view of a two input transceiver matched to a 50 ohm loop antenna;

FIG. 1b illustrates the embodiment of FIG. 1a with the exception that the two terminals are processed through a balun to a single ended antenna;

FIG. 2a illustrates the embodiment of FIG. 1a with the exception that the output is matched to a 100 ohm loop antenna;

FIG. 2b is similar to the embodiment of FIG. 1b with the exception that a 100 ohm balun is utilized to match the network to a single ended 100 ohm antenna;

FIG. 3 illustrates a diagrammatic view of the embodiment of FIG. 1 with only a single ended 50 ohm antenna associated therewith;

FIG. 4 illustrates the embodiment of FIG. 3 with the exception that the single ended antenna is disposed on a different terminal;

FIG. 5 illustrates an embodiment wherein the two terminals to the transceiver are connected such that reception is provided on one terminal and transmission is provided on the second terminal, this being single ended reception, and a switch is provided for interfacing to a single ended 50 ohm antenna;

FIG. 6 illustrates an embodiment where two single ended 50 ohm antennas are connected to respective ones of the inputs and are disposed at different orientations;

FIG. 7 illustrates a diagrammatic view illustrating the configuration of the LNA and the PA;

FIG. 8 illustrates the embodiment of FIG. 7 with the exception of a matching network provided external to the chip;

FIG. 9 illustrates a diagrammatic view of one terminal and interconnection of the LNA and the PA with switched capacitors provided; and

FIG. 10 illustrates a schematic diagram of the differential LNA.

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

Referring now to FIG. 1a, there is illustrated a diagrammatic view of an integrated circuit transceiver 102 which represents a monolithic RF transmitter/receiver combination comprised of a differential low noise amplifier (LNA) 104 and a differential power amplifier (PA) 106. There is provided a multiplexer 108 which is operable to interface to two terminals 110 and 112. The terminals 110 and 112 are adaptable to have a varying input impedance that can be matched to various antenna configurations. In the embodiment of FIG. 1a, a ring or loop antenna 114 is provided which is operable to connect on one end thereof to the terminal 110 and on the other end thereof to the terminal 112. This antenna 114 can be fabricated in many different manners. In a simple fabrication, this can be formed on a printed circuit board, which printed circuit board has a predefined thickness, material and line width and typically includes some type of ground plane. However, the loop antenna 114 could be a wire in free space also. The length of the loop forming the antenna 114 is a function of the frequency thereof. For applications such as IEEE 802.11 bg wireless Ethernet, the frequency operates in the 2.4 GHz band. Although this part is in the ISM band, this particular application is not to be considered to be an ISM application; rather, it falls under the regulations of Part 15 of the Federal Communication Communications (FCC) Rules and Regulations. These are typically associated with unlicensed transmissions.

In operation, the multiplexer 108 is operable in a receive mode to connect the terminals 110 and 112 to the two input terminals of the differential LNA 104. In the transmit mode, the multiplexer 108 is operable to connect the two outputs of the differential power amplifier 106 to the terminals 110 and 112. A switch control 118 is provided for controlling the multiplexer 108. As will be described herein below, there are also additional switches disposed within the device which are utilized to tune the impedance and/or the frequency for the various inputs and configurations.

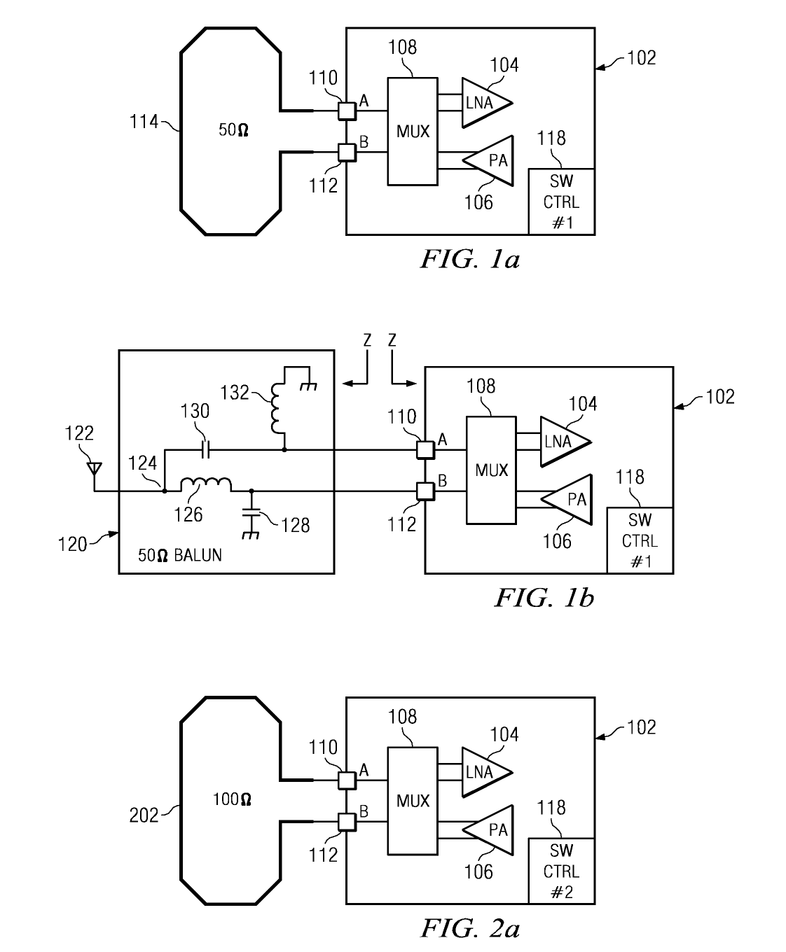

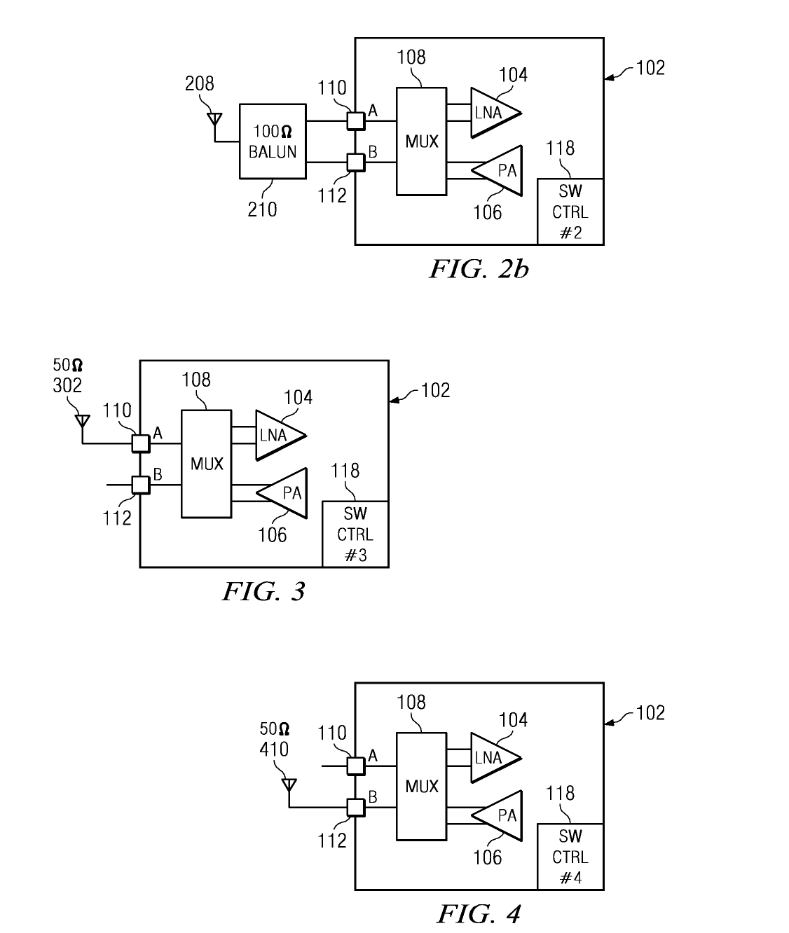

Referring now to FIG. 2, there is illustrated an alternate embodiment of the embodiment of FIG. 1a. In the embodiment of FIG. 2, the input terminals 110 and 112 are interfaced to two inputs of a 50 ohm balun 120. The balun 120 is operable to interface the two inputs to a single ended 50 ohm antenna 122. The balun 120 can be any type of typical balun, a generic example of which is illustrated in FIG. 2. In this example, the antenna 122 is connected to a node 124. The node 124 is connected to one side of an inductor 126, the other side thereof connected to the terminal 112. A capacitor 128 is connected between terminal 112 and ground. A capacitor 130 is connected between node 124 and terminal 110 with an inductor 132 connected between node 110 and ground. This is a typical balun in that it matches a single ended antenna to a double ended differential input/output. Both FIGS. 1a and 1b provide for differential reception and transmission from and to a 50 ohm antenna or balun.

Referring now to FIG. 2a there is a diagrammatic view of the embodiment of FIG. 1a with the exception that the antenna is a 100 ohm printed antenna or balun, this being a loop antenna 202. This loop antenna 202 is connected on one side thereof to the terminal 110 and on the other side thereof to the terminal 112. The difference between the configuration of FIG. 1a and the configuration of 1b is that the input impedance to node 110 looking into the integrated circuit package 102 and the input impedance looking into terminal 112 of the integrated circuit package 102 is different from that of FIG. 1a. The switch control 118 is operable to control this and a second configuration.

Referring now to FIG. 2b, there is illustrated an alternate embodiment to that of FIG. 1b. In this embodiment, a single ended 100 ohm antenna 208 is interfaced to the input terminals 110 and 112, a 100 ohm balun 210.

Referring now to FIG. 3, there is illustrated an alternate embodiment of FIGS. 1a and 1b with the switch control 118 configured in a third configuration to provide for single ended reception on a single input from a 50 ohm antenna 302. In this configuration, the 50 ohm antenna is interfaced to the terminal 110. As such, the LNA 104 is now oriented for single ended reception and the PA 106 is oriented for single ended transmission. The multiplexer 108 interfaces the select output of the PA 106 or the select output of the LNA 104 to only the terminal 110 and the impedance thereof is matched to the 50 ohm antenna 302.

Referring now to FIG. 4, there is illustrated an alternate embodiment to that of FIG. 3, wherein the switch 118 is configured in a fourth configuration to allow a 50 ohm antenna 410 to be interfaced to the terminal 112 and the terminal 110 having nothing connected thereto. In this configuration, the multiplexer 108 is operable to interface the terminal 112 to one input of the LNA 104 for a single ended receive operation or to one output of the PA 106 for a single ended transmission operation. Again, the terminal 112 must be configured to have an input impedance matching the input impedance to the amplifier for both sufficient low noise reception by the LNA 104 and for maximum power input by the power amplifier 106.

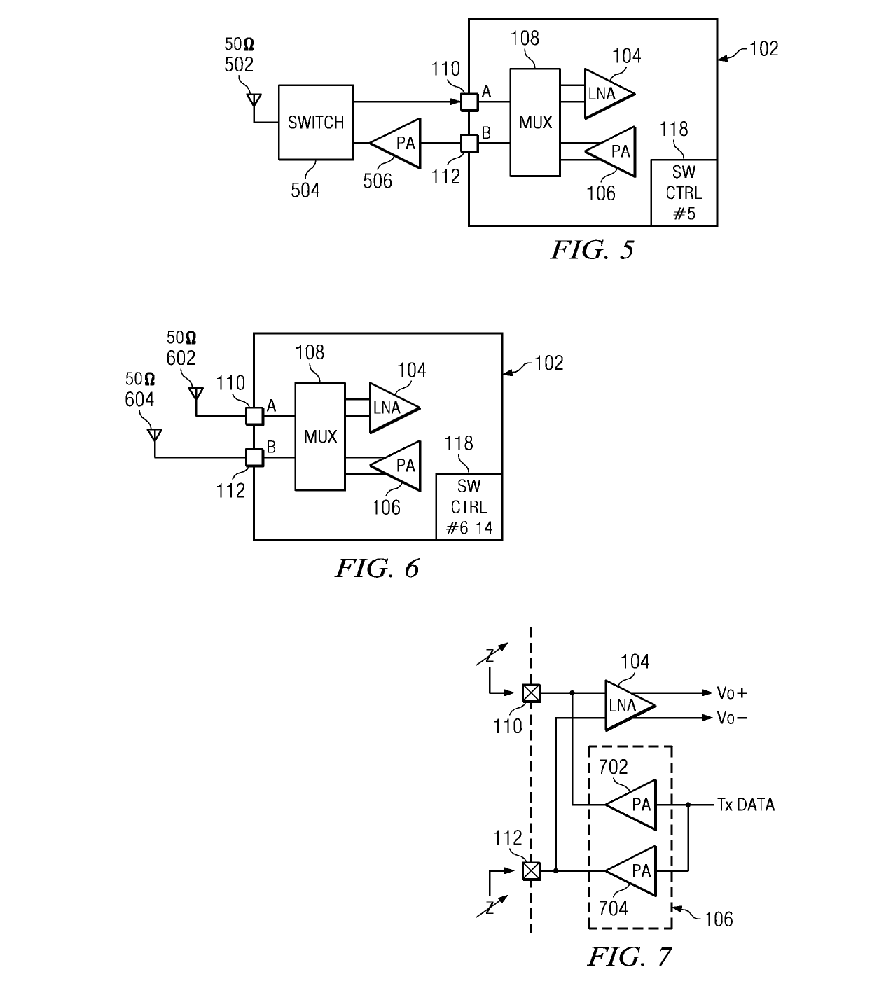

Referring now to FIG. 5, there is illustrated an alternate embodiment of the present invention. The chip 102 has the two terminals 110 and 112 interfaced such that terminal 110 is dedicated to single ended reception and the terminal 112 is dedicated to single ended transmission. In this embodiment, the terminal 110 is matched to the impedance of a 50 ohm single ended antenna 502. A switch 504 is operable to switch between transmit and receive and this typically is called a T/R switch. In the reception mode, the antenna output is connected to terminal 110, which is matched to the impedance of the antenna 502. The LNA 104 operates, under this configuration, in a single ended mode. In the transmission mode, an external power amplifier 506 is provided to boost the power. In this mode, it is then only necessary to be able to match the input impedance on terminal 112 to that of the power amplifier 506. Typically, most RF amplifiers will have a nominal 50 ohm input impedance with substantially no imaginary part associated therewith. This will be controlled by the switch 118 in a fifth configuration. Additionally, it should be understood that the configuration of terminals 110 and 112 could be reversed such that reception is on terminal 112 and transmission is on terminal 110, with terminal 110 driving the power amplifier 506.

Referring now to FIG. 6, there is illustrated an alternate embodiment wherein the terminals 110 and 112 are connected to individual respective 50 ohm antennas 602 and 604. In this configuration, the antennas 602 and 604 can be connected with any combination of receiving and transmitted on A (110) or B (112) or on both A (110) and B (112). As such, the respective antenna 602 or 604 could receive information on terminal 112 and transmit information on terminal 110 or it could receive information on both or transmit information on both.

In this embodiment, with two separate antennas, the antennas can be disposed at locations different from each other. For example, antenna 602 could be disposed exterior to a structure and antenna 604 could be stored interior thereto. This allows each antenna to be interface to a different radiation environment. Also, it is well known that reception for any antenna is a function of the surrounding environment, and the received signal strength at the antenna. If an antennas were disposed in such a manner that the received signal strength at each of the respective antennas were different, it is possible to utilize a receive signal strength indicator (RSSI) to detect the received signal strength at each of the antennas and select there between for the strongest signal. For example, in a laptop computer, the most desirable antenna would be one that were exposed to the air free of any surrounding loads, such as a housing, external dielectric surfaces (such as a human hand), etc. However, if an individual disposes this next to their leg, the reception can be significantly degraded. Thus, a protected antenna in the laptop housing may be a better selection. With the ability to select between two antennas, reception at the reeiver can be enhanced.

Referring now to FIG. 7, there is illustrated a diagrammatic view of the interface inside the package to the terminals 110 and 112. Although a multiplexer 108 was illustrated, the terminals 110 and 112 are actually connected directly to the input of the LNA 104 or to the output of the PA 106. The LNA 104 is a differential input LNA with a differential output, such that both inputs to the differential LNA 104 are connected to respective ones of the terminals 110 and 112. The PA 106 is comprised of two separate power amplifiers 702 and 704, that drive respective ones of the terminals 110 and 112. A single transmit input into the amplifiers is provided, which will then provide differential output therefrom. This is a conventional driving configuration. As will be described herein below, it can be appreciated that, during reception, even though the power amplifiers 702 and 704 are turned off, they will still “load” terminals 110 and 112 and, thus, the LNA 104 must accommodate this. During transmission, the LNA 104 will provide loading to the terminals 110 and 112. By providing matching networks therein, as will be described herein below, the loading of the terminals with the respective circuitry can be accommodated. In order to accommodate the different output impedances for the various loads, the input impedance of the two nodes 110 and 112 looking inward thereto is tunable, such that it will vary the function of the configuration.

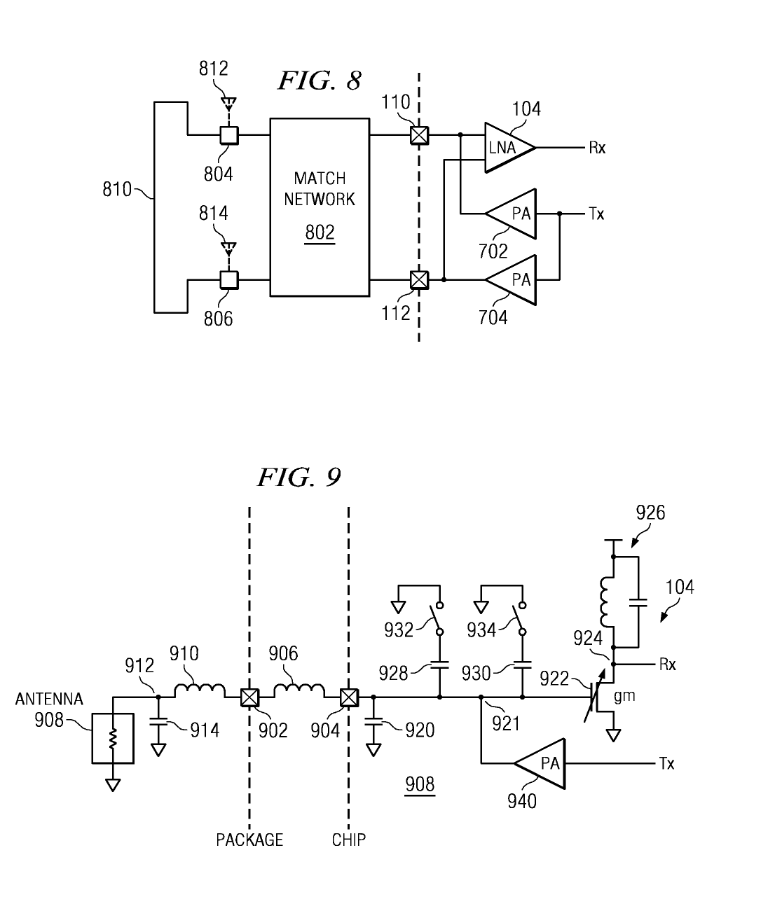

Referring now to FIG. 8, there is illustrated a more detailed embodiment illustrating the actual application, wherein a matching network 802 will be provided to match the terminals 110 and 112 to the various configurations of the antenna, whether that antenna be a 50 ohm antenna or a 100 ohm antenna. This matching network will adjust the real and imaginary part of the impedance such that it is more closely adapted to what is achievable in the integrated circuit. This matching network interface interfaces to interface terminals 804 and 806, corresponding to terminals 110 and 112, such that they can be connected to a loop antenna 810 or to respective single ended antennas 812 and/or 814 (in phantom).

Referring now to FIG. 9, there is illustrated in more detailed diagrammatic view of the LNA 104 and the interface between the LNA 104 and the PA 106. In this illustration, there is illustrated only one of the terminals 110 and 112 and its associated node interface. The package has a terminal 902 for interfacing with the antenna and the terminal 902 is connected to a bond pad 904 on the chip through a bond wire represented by an inductance 906. The chip is referred to by the reference numeral 908. The exterior of the chip on the terminal 902 is interfaced to an antenna 908 through a matching network, represented by a series inductor 910 connected between terminal 902 and a node 912, there being a capacitor 914 disposed between node 912 and ground. The antenna 908 is disposed between node 912 and ground also. This inductor 910 and capacitor 914 are representative of a matching network, similar to the matching network 802 in FIG. 8. The antenna 908 represents a single ended amplifier with either an impedance of 50 ohm or 100 ohm.

Internal to the chip and attached to the bond pad 904 is a typical parasitic capacitance 920 with one end thereof connected to a node 921 (node 921 connected to bond pad 904) and the other side thereof connected to ground (or the substrate bulk). This can be the capacitance associated with the node 921, but more particularly it is the capacitance associated with the electrostatic protection device associated with the pad (ESD). This capacitance will always be associated with the node and must be accounted for in the driving capabilities for the power amplifier 106. The LNA 104 on one portion of the differential input thereof is comprised of an MOS transistor 922 having the gate thereof connected to the terminal 904 and the node 921, with the source thereof connected to ground and the drain thereof connected to an output node 924. A resonant tank circuit 926 is connected between node 924 and power supply terminal V_{DD}. The node 924 comprises the output node of the LNA for the received signal which is amplified by the transistor 922. This transistor 922 has a variable gₘ such that the gain thereof is varied but, also, the impedance will be varied with the variable gₘ. This provides one parameter to control the input impedance on the node 921 during the receive mode. In addition to the varying gₘ, there are also provided two switched capacitors 928 and 930 connected between node 921 and respective switches 932 and 934. The other side of the switches 932 and 934 are connected to ground. As will be described herein below, during the receive mode, both capacitors 928 and 930 have the associated switches thereof connected to ground when the antenna is a 50 ohm antenna and the terminating impedance is 50 ohms. For 100 ohms, only one of the capacitors 928 and 930 is connected to ground. During transmission, both capacitors are disconnected from the ground. Further, the LNA 104, during transmission, is disabled.

The power amplifier, represented by a PA 940, drives the node 921 during transmission and the removal of the two capacitors 920 and 930 is operable to allow the output of the transmitter 940 to drive a load that is tuned to optimize power transmission. In general, the frequency response for the node 921 during transmission will be somewhat low if one or both of the capacitors 928 or 930 are connected to ground for the purpose of tuning the input to the LNA 104. If this is not changed, it has been determined that the pass band will be at a center frequency lower than the desired frequency of PA 940. Thus, by disconnecting the two capacitors 928 and 930 from ground, the center frequency of the pass band will actually be shifted higher such that the center frequency of the PA 940 will be moved upward to optimize power for transmission. Thus, it can be seen that, during the receive mode, the power amplifier 940 need only be disabled such that it represents a load on the node 921, this load typically being a capacitive load. Thus, the matching network includes the output capacitance of the PA 940 when it is disabled. Typically, this is a mode wherein the output is placed into a three-state mode wherein the node 921 is neither driven from the power supply or sinked to ground, i.e., it is not driven. At the same time, additional matching circuitry is switched in to basically “tune” the input impedance of the LNA to match the particular antenna load, this configuration depending upon what the antenna load is. Further, the actual parameters of the LNA can be tuned depending upon the load to provide additional matching. During transmission, the LNA is disabled such that it now becomes a capacitive load on the node 921, but the capacitors 928 and 930 which are switched in during reception can be switched out, thus changing the matching network associated with node 921. It can be seen that internal configuration controls are all that are required and only a single bond pad 904 need be associated with both transmission and reception for one side of the differential input. This eliminates the need for expensive and space consuming switches associated with the pad 904.

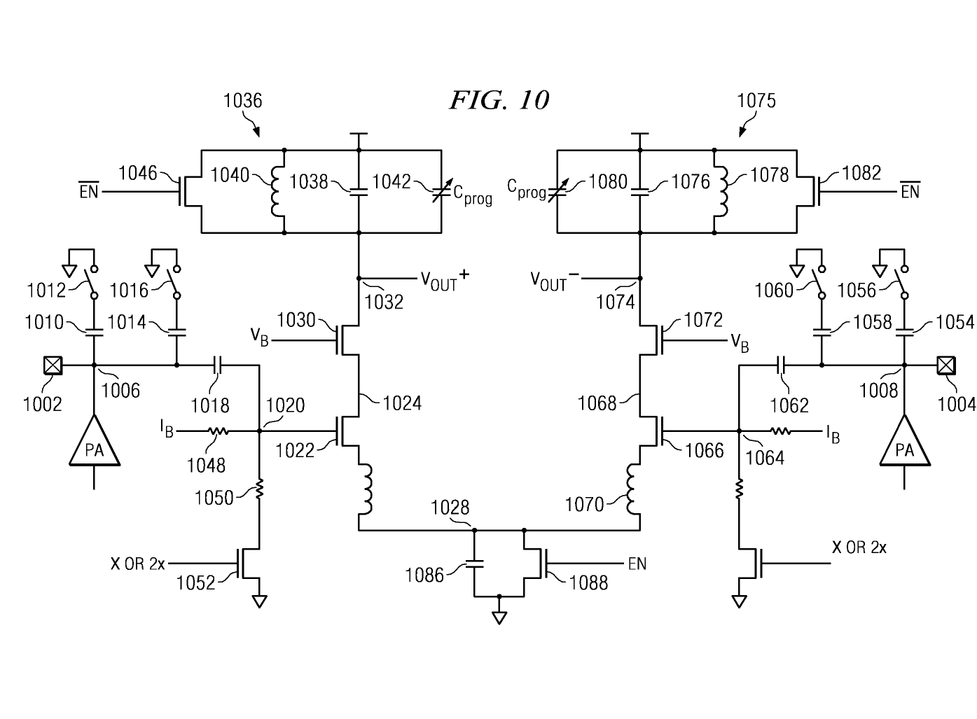

Referring now to FIG. 10, there is illustrated a more detailed diagram of the differential LNA. In FIG. 10, there are illustrated two terminals (or pads) 1002 and 1004, corresponding to the terminals 110 and 112 of FIG. 1a. This provides the differential inputs to the LNA. Terminal 102 is associated with a node 1006 and terminal 1004 is associated with a node 1008. On node 1006, there is provided a first capacitor 1010 connected between node 1006 and one side of a switch 1012, the other side thereof connected to ground, and a second capacitor 1014 connected between node 1006 and one side of the switch 1016, the other side thereof connected to ground. A series capacitor 1018 is connected between node 1006 and a node 1020 to provide DC isolation between nodes 1006 and node 1020. Node 1020 drives the gate of a first differential transistor 1022 in a first leg. The source/drain of transistor 1022 is connected between a node 1024 and one side of an inductor 1026. The other side of the inductor 1026 is connected to a common node 1028. A bias transistor 1030 has the source/drain path thereof connected between an output node 1032 and node 1024, and the gate thereof connected to a bias voltage V_{B}. The node 1032 is connected to one side of a tank circuit 1036, the other side thereof connected to V_{DD}. The tank circuit 1036 is comprised of a capacitor connected between node 1032 and V_{DD}, a capacitor 1038 connected between node 1032 and V_{DD}, a parallel inductor 1040 connected thereacross and a variable capacitor 1042 connected thereacross. The variable capacitor 1042 is programmed by a digital signal C_{prog}. This capacitor 1042 is a trim capacitor that basically fine tunes the band pass or frequency response of the LNA. An Enable transistor 1046 has the source/drain thereof connected across the tank circuit 1036 and the capacitor 1038 and inductor 1040, and is connected to the Enable-Bar signal. When the Enable signal is present, transistor 1046 is turned off. When the Enable signal is not present, the tank 1042 is shorted and V_{DD} is connected to node 1032.

A bias voltage is provided to node 1020 on the gate of transistor 1022 with a bias circuit comprised of the first resistor connected between an input bias current I_{B} through a resistor 1048 to node 1020. A second resistor 1050 is connected between node 1020 and one side of the source/drain path of transistor 1052, the other side thereof connected to ground. The gate of transistor 1052 is connected to a signal that basically controls the current therethrough for two levels, one being X and the other being 2×. This basically is a voltage that will vary the current through transistor 1022 to be two different levels (basically it varies the current by a factor of 2×), such that the gₘ will be varied. By varying this gₘ, the input impedance on node 1006 will be varied.

A second leg is provided which is associated with the terminal 1004 connected to a node 1008. The node 1008 associated therewith is connected to one side of a capacitor 1054, the other side thereof connected to a switch 1056, the other side of switch 1056 connected to ground. A second capacitor 1058 has one side thereof connected to node 1008 and the other side thereof connected to one side of a switch 1060, the other side of switch 1060 connected to ground. The capacitors 1054 and 1058, as well as capacitors 1010 and 1014, are switched in and out, depending upon whether the transceiver is in the receive mode and depending upon the load. A blocking series capacitor 1062 is connected between node 1058 and a node 1064, node 1064 connected to the gate of a second differential transistor 1066, the source/drain path thereof connected between a node 1068 and one side of an inductor 1070, the other side of inductor 1070 connected to node 1028. A bias transistor 1072 has the source/drain path thereof connected between an output node 1074 and node 1068, the base thereof connected to the bias voltage V_{D}. A tank circuit 1075 is provided that is similar to tank circuit 1036. This has a parallel capacitor 1076, a parallel inductor 1078 and a parallel variable capacitor 1080 controlled by the program signal C_{prog}. Similarly, an enable transistor 1082 is provided connected across the tank circuit 1075 with the base thereof connected to the Enable-Bar signal. Additionally, the node 1028 has a capacitance 1086 associated therewith connected between node 1028 and ground. An Enable transistor 1088 has the source/drain path thereof connected between node 1028 and ground and the gate thereof connected to the Enable signal. During operation, the node 1028 is connected ground and, when disabled, node 1028 is only connected through capacitor 1086 to ground. Thus, when disabled, the two capacitors 1010 and 1014 associated with terminal 1002, for example, will be disconnected from ground to their respective switches 1012 and 1016, such that the load to node 1006 will essentially be the series capacitance of the capacitor 1018, the gate-to-source capacitance of transistor 1022 and the capacitance of capacitor 1086, all in a series. Additionally, the voltage on the transistor 1052 can be varied to change the voltage on the gate of transistor 1022. In addition to changing the load, by raising the voltage along node 1028 from ground, this decreases the gate-to-gate source voltage (V_{gs}) across the transistor 1022, thus protecting the transistor 1022 from high voltages that may be present during transmission. This is useful, as the transistors utilized in the LNA incorporate low voltage gate oxide.

It will be appreciated by those skilled in the art having the benefit of this disclosure that this invention provides a transceiver with configurable transmit and receive impedances that allow for the accommodation of different transmit and receive loads. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

1. An RF interface for interfacing between a differential transceiver and at least two antenna ports, which transceiver has at least two receive inputs for receiving RF signals from the at least two antenna ports and at least two transmit outputs for transmitting RF signals to the at least two antenna ports, comprising:
a multiplexing device for interfacing between the transceiver and the at least two antenna ports and selectively interface transmitted RF signals to one or both of the at least two antenna ports or selectively interface received signals from one or both of the at least two antenna ports to respective receive inputs of the transceiver;
a controller for controlling said multiplexer to operate in either a receive mode or a transmit mode and, in the receive mode, operate in either a single ended mode to interface one of the at least two antenna inputs to one of the inputs of the transceiver or a differential mode to interface both of the at least two antenna inputs to respective inputs of the transceiver; and
a matching network controlled by said controller for matching the impedance of the at least two antenna ports to the input of the transceiver when in the receive mode, and operable to select between at least tow different antenna impedances.

2. The interface of claim 1, wherein the transceiver has a differential receiver comprised of first and second receivers that can operate in a differential mode or a single ended mode, and a differential transmitter comprised of first and second transmitters that can operate in a differential mode or a single ended mode, said multiplexer is operable to maintain a hardwire connection between respective said first and second receivers and said first and second transmitters and respective ones of the at least two antenna ports, said matching network controlled to provide the correct matching in both single ended and differential operation modes.

3. The interface of claim 2, wherein said controller is operable to control said multiplexer to operate in a differential mode or a single ended mode during the transmit mode and said matching network is controllable to match the impedance of the outputs of said transmitters to the input impedances of the respective ones of the at least two antenna ports.

4. The interface of claim 3, wherein said matching network is operable to vary the frequency response of the interface between the hardwire connection to said first and second receivers and said first and second transmitters when switching between transmit and receive modes.

5. The interface of claim 2, wherein said matching network is operable to vary the input impedance of said first and second receivers when switching between transmit and receive modes of operation.

6. The interface of claim 5, wherein said multiplexer and said matching network are formed on a common integrated circuit with the transceiver.

7. The interface of claim 1, wherein said multiplexer and said matching network are formed on a common integrated circuit with the transceiver.

8. The interface of claim 1, wherein said matching network includes at least a single switched capacitor associated with each of the at least two antenna inputs to provide a selective capacitive load to the respective inputs of the transceiver to allow selection between the at least two impedances.

9. The interface of claim 1, wherein, in the single ended mode of operation, the multiplexer can be controlled to connect only a single one of the at least two antenna inputs to a respective one of the transceiver inputs.

10. The interface of claim 9, wherein, in the single ended mode of operation, two different antennas can be connected to respective ones of the at least two antenna inputs and the multiplexer can be controlled to connect each of the at least two antenna inputs to a respective one of the transceiver inputs for single ended operation from each of the at least two antenna inputs.

11. The interface of claim 1, wherein, in the differential mode of operation, the multiplexer can be controlled to connect both of the at least two antenna inputs to a respective ones of the transceiver inputs for differential operation wherein a loop antenna is connected between the at least two antenna inputs.
